(19) United States
(12) Patent Application Publication
(10) Pub. No.: US 2007/0106036 A1
(43) Pub. Date: May 10, 2007

(54) Semiconductor encapsulating epoxy resin composition and semiconductor device

(75) Inventors: Eiichi Asano, Annaka-shi (JP); Yasuo Kimura, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/593,108

(22) Filed: Nov. 6, 2006

(30) Foreign Application Priority Data
Nov. 7, 2005 (JP) 2005-322754

(51) Int. Cl. C08L 63/02; C08G 77/42

(52) U.S. Cl. 525/476; 528/25

(57) ABSTRACT

An epoxy resin composition comprising (A) a naphthalene type epoxy resin in which 35-85 parts by weight of 1,1-bis(2-glycidyloxy-1-naphthyl)alkane and 1-35 parts by weight of 1,1-bis(2,7-diglycidyloxy-1-naphthyl)alkane are included per 100 parts by weight of the resin, (B) a phenolic resin curing agent, (C) a copolymer obtained through addition reaction of alkenyl groups on an alkenyl-containing epoxy compound and SiH groups on an organohydrogenpolysiloxane of 20 to 50 silicon atoms, and (D) an inorganic filler is best suited for semiconductor encapsulation because the cured composition has good thermal cycling, anti-warping, reflow resistance, and moisture-proof reliability.

### CROSS-REFERENCE TO RELATED APPLICATION

This non-provisional application claims priority under 35 U.S.C. §119(a) on Patent Application No. 2005-322754 filed in Japan on Nov. 7, 2005, the entire contents of which are hereby incorporated by reference.

This invention relates to an epoxy resin composition for semiconductor encapsulation which forms a cured product having good thermal cycling, anti-warping, reflow resistance, and moisture-proof reliability. It also relates to a semiconductor device encapsulated with a cured product of the composition.

### BACKGROUND ART

The current mainstream of semiconductor devices including diodes, transistors, ICs, LSIs and VLSIs are of the resin encapsulation type. Epoxy resins have superior moldability, adhesion, electrical properties, mechanical properties, and moisture resistance to other thermosetting resins. It is thus a common practice to encapsulate semiconductor devices with epoxy resin compositions.

In harmony with the recent market trend of electronic equipment toward smaller size, lighter weight and higher performance, efforts are devoted to the fabrication of semiconductor members of larger integration and the promotion of semiconductor mount technology. Under the circumstances, more stringent requirements including lead elimination from solder are imposed on epoxy resins as the semiconductor encapsulant.

Recently, ball grid array (BGA) and QFN packages characterized by a high density mount become the mainstream of IC and LSI packages. For these packages which are encapsulated only on one surface, the problem of warpage after molding becomes more serious.

The miniaturization trend of the LSI fabrication process encouraged the development of low-k inter-level dielectric (ILD) films having a lower dielectric constant of 1.1 to 3.8. In practice, doped silicon oxide films such as SiOF, organic polymer films, and porous silica have been used as the low-k ILD film. These low-k ILD films have low mechanical strength and thus suffer from serious problems that delamination occurs at the interface between the encapsulant and the low-k ILD film during solder reflow or subsequent thermal cycling and cracks generate within the low-k ILD film or encapsulant.

Japanese Patent No. 3,137,202 discloses an epoxy resin composition comprising an epoxy resin and a curing agent wherein the epoxy resin used is 1,1-bis(2,7-diglycidyloxy-1-naphthyl)alkane. This epoxy resin composition in the cured state has good heat resistance and excellent moisture resistance, and overcomes the drawback that cured products of ordinary high-temperature epoxy resin compositions are hard and brittle.

JP-A 2005-15689 describes an epoxy resin composition comprising (A) an epoxy resin comprising (a1) 1,1-bis(2,7-diglycidyloxy-1-naphthyl)alkane, (a2) 1-(2,7-diglycidyloxy-1-naphthyl)-1-(2-glycidyloxy-1-naphthyl)alkane, and (a3) 1,1-bis(2-glycidyloxy-1-naphthyl)alkane, and (B) a curing agent wherein 40 to 95 parts by weight of (a3) is included per 100 parts by weight of (a1), (a2) and (a3) combined. It is described that inclusion of 40 to 95 parts by weight of the resin of formula (1), shown later, wherein m=n=0 is preferred from the standpoints of flow and curability.

The inventors have discovered that an epoxy resin having the same naphthalene structure as above has good flow, a low coefficient of linear expansion, a high glass transition temperature (Tg), minimal moisture absorption, and soldering crack resistance when the content of the resin of formula (1) wherein m=1 and n=1 is also limited to a certain range.

### DISCLOSURE OF THE INVENTION

An object of the present invention is to provide an epoxy resin composition for semiconductor encapsulation which forms a cured product having good thermal cycling, anti-warping, reflow resistance, and moisture-proof reliability. Another object is to provide a semiconductor device encapsulated with the epoxy resin composition in the cured state.

The invention provides a semiconductor encapsulating epoxy resin composition comprising

(A) a naphthalene type epoxy resin having the general formula (1): 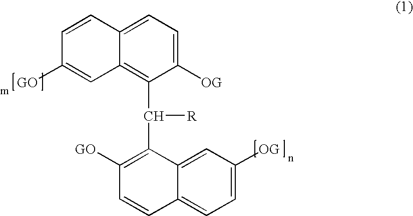
wherein m and n are 0 or 1, R is hydrogen, C₁-C₄ alkyl or phenyl, and G is a glycidyl-containing organic group, with the proviso that 35 to 85 parts by weight of the resin wherein m=0 and n=0 and 1 to 35 parts by weight of the resin wherein m=1 and n=1 are included per 100 parts by weight of the resin of formula (1),

(B) a phenolic resin curing agent,

(C) a copolymer obtained through addition reaction of alkenyl groups on an alkenyl-containing epoxy compound and SiH groups on an organopolysiloxane having the average compositional formula (2):
HₐR¹_{b}SiO_{(4-a-b)/2} (2)
wherein R¹ is substituted or unsubstituted monovalent hydrocarbon group, hydroxyl group or alkoxy group, a is a positive number of 0.01 to 1, b is a positive number of 1 to 3, and the sum a+b is from 1 to 4, the number of silicon atoms per molecule is an integer of 20 to 50, and the number of silicon-bonded hydrogen atoms per molecule is an integer of at least 1, and

(D) an inorganic filler.

Also contemplated herein is a semiconductor device encapsulated with a cured product of the epoxy resin composition.

### BENEFITS OF THE INVENTION

The epoxy resin composition of the invention forms a cured product having good thermal cycling, anti-warping, reflow resistance, and moisture-proof reliability. It is best suited for semiconductor encapsulation. The semiconductor device encapsulated with a cured product of the epoxy resin composition is of great worth in the industry.

### BRIEF DESCRIPTION OF THE DRAWING

FIG. 1 is a diagrammatic representation of the IR reflow schedule for reflow resistance measurement.

### DESCRIPTION OF THE PREFERRED EMBODIMENTS

The epoxy resin composition of the invention for semiconductor encapsulation comprises (A) an epoxy resin, (B) a phenolic resin curing agent, (C) a specific copolymer, and (D) an inorganic filler.

A. Epoxy Resin

The epoxy resin (A) comprises a naphthalene type epoxy resin having the general formula (1). 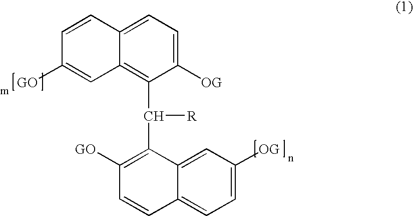
In formula (1), m and n are 0 or 1, R is a hydrogen atom, C₁-C₄ alkyl group or phenyl group, and G is a glycidyl-containing organic group. It is essential that 35 to 85 parts by weight of the resin wherein m=0 and n=0 and 1 to 35 parts by weight of the resin wherein m=1 and n=1 be present per 100 parts by weight of the resin of formula (1).

If the resin wherein m=0 and n=0 is less than 35 parts by weight per 100 parts by weight of the resin of formula (1), the resin composition has a high viscosity and is less flowable. If the same resin is more than 85 parts by weight, the resin composition undesirably has an extremely low crosslinking density, less curability and a low Tg. If the resin wherein m=1 and n=1 is more than 35 parts by weight per 100 parts by weight of the resin of formula (1), the resin composition has an increased crosslinking density and an increased Tg, but is undesirably increased in modulus of elasticity at high temperature. In order that the epoxy resin composition have satisfactory curability, heat resistance and modulus of elasticity at high temperature, it is preferred that the content of the resin wherein m=0 and n=0 be 45 to 70 parts by weight and the content of the resin wherein m=1 and n=1 be 5 to 30 parts by weight.

JP-A 2005-15689 describes that inclusion of 40 to 95 parts by weight of the resin of formula (1) wherein m=n=0 is preferred from the standpoints of flow and curability. The inventor has discovered that an epoxy resin having the same naphthalene structure as above has good flow, a low coefficient of linear expansion, a high Tg, minimal moisture absorption, and soldering crack resistance when the content of the resin of formula (1) wherein m=1 and n=1 is also limited to a certain range.

Specific examples of these epoxy resins are shown below. 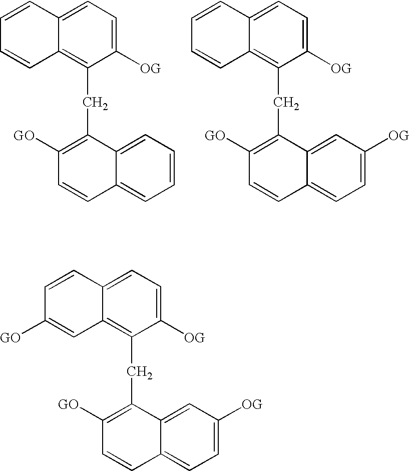
Note that R and G are as defined above.

Illustrative examples of R include hydrogen atoms, alkyl groups such as methyl, ethyl and propyl, and phenyl groups. One typical example of the glycidyl-containing organic group of G is shown below.

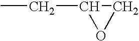

In the inventive composition, another epoxy resin may be used in combination with the naphthalene epoxy resin having formula (1) as the epoxy resin component. The other epoxy resin used herein is not critical and is selected from prior art well-known epoxy resins including novolac type epoxy resins (e.g., phenol novolac epoxy resins, cresol novolac epoxy resins), triphenolalkane type epoxy resins (e.g., triphenolmethane epoxy resins, triphenolpropane epoxy resins), biphenyl type epoxy resins, phenol aralkyl type epoxy resins, biphenyl aralkyl type epoxy resins, heterocyclic epoxy resins, naphthalene ring-containing epoxy resins other than formula (1), bisphenol type epoxy resins (e.g., bisphenol A epoxy resins, bisphenol F epoxy resins), stilbene type epoxy resins, and halogenated epoxy resins. The other epoxy resins may be employed alone or in combination of two or more.

It is desired that the naphthalene epoxy resin having formula (1) account for 50 to 100% by weight, more preferably 70 to 100% by weight of the entire epoxy resin component (i.e., naphthalene epoxy resin of formula (1)+other epoxy resins). If the proportion of the naphthalene epoxy resin is less than 50% by weight, some of the desired properties including heat resistance, reflow resistance and moisture absorption may be lost.

B. Curing Agent

A phenolic resin is included in the epoxy resin composition of the invention as a curing agent for the epoxy resin (A). The phenolic resin is not particularly limited, and use may be made of prior art well-known phenolic resins including phenol novolac resins, naphthalene ring-containing phenolic resins, phenol aralkyl type phenolic resins, aralkyl type phenolic resins, biphenyl skeleton-containing aralkyl type phenolic resins, biphenyl type phenolic resins, dicyclopentadiene type phenolic resins, alicyclic phenolic resins, heterocyclic phenolic resins, and bisphenol type phenolic resins (e.g., bisphenol A and bisphenol F phenolic. resins). These phenolic resins may be employed alone or in combination of two or more. Inter alia, it is most preferred to use phenolic resins having at least one substituted or unsubstituted naphthalene ring per molecule.

No particular limit is imposed on the proportion of phenolic resin (B) relative to epoxy resin (A). The phenolic resin is preferably used in such amounts that the molar ratio of phenolic hydroxyl groups in the curing agent to epoxy groups in the epoxy resin is from 0.5 to 1.5, and more preferably from 0.8 to 1.2.

C. Copolymer

Essential in the epoxy resin composition of the invention is (C) a copolymer which is obtained through addition reaction of alkenyl groups on an alkenyl-containing epoxy compound and SiH groups on an organopolysiloxane having the average compositional formula (2).
HₐR¹_{b}SiO_{(4-a-b)/2} (2)
Herein R¹ is substituted or unsubstituted monovalent hydrocarbon group, hydroxyl group or alkoxy group, a is a positive number of 0.01 to 1, b is a positive number of 1 to 3, and the sum a+b is from 1 to 4, the number of silicon atoms per molecule is an integer of 20 to 50, and the number of silicon-bonded hydrogen atoms per molecule is an integer of at least 1.

In formula (2), the monovalent hydrocarbon groups represented by R¹ are preferably of 1 to 10 carbon atoms, more preferably 1 to 8 carbon atoms, for example, alkyl groups such as methyl, ethyl, propyl, isopropyl, butyl, isobutyl, tert-butyl, hexyl, cyclohexyl, octyl, and decyl; alkenyl groups such as vinyl, allyl, propenyl, butenyl, and hexenyl; aryl groups such as phenyl, xylyl, and tolyl; aralkyl groups such as benzyl, phenylethyl, and phenylpropyl; and halo-substituted monovalent hydrocarbon groups in which some or all hydrogen atoms are substituted by halogen atoms (e.g., chlorine, fluorine or bromine), such as chloromethyl, bromoethyl, and trifluoropropyl.

In one molecule of the organopolysiloxane (2), the number of silicon atoms is 20 to 50, and preferably 30 to 40. An organopolysiloxane with less than 20 silicon atoms per molecule may allow the siloxane component to bleed out, leading to poor reflow resistance. An organopolysiloxane with more than 50 silicon atoms has a larger domain size and may fail to provide good thermal cycling properties.

In formula (2), the preferred ranges of a and b are 0.01≦a≦0.5, 1.5≦b≦2.5, and 1.5≦a+b≦3. The number of silicon-bonded hydrogen atoms (i.e., SiH groups) per molecule is preferably 1 to 10, more preferably 1 to 5. The organopolysiloxane content in the copolymer is preferably 5 to 50% by weight, more preferably 10 to 30% by weight.

The method of preparing the copolymer used herein is per se known from JP-B 63-60069 and JP-B 63-60070. The copolymer can be prepared by effecting addition reaction between alkenyl groups on an alkenyl-containing epoxy compound and SiH groups on an organopolysiloxane of formula (2). Exemplary copolymers have a structure of the following formula (3). 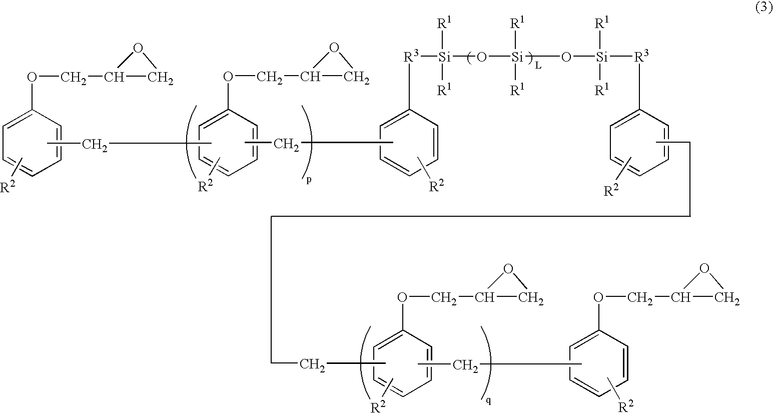
Herein, R¹ is as defined above. R² is hydrogen or a monovalent hydrocarbon group of 1 to 6 carbon atoms. R³ is —CH₂CH₂CH₂—, —OCH₂—CH(OH)—CH₂—O—CH₂CH₂CH₂— or —O—CH₂CH₂CH₂—, L is an integer of 18 to 48, and preferably 28 to 38, and p and q each are an integer of 1 to 100, and preferably 2 to 50.

In formula (3), the monovalent hydrocarbon groups represented by R² are of 1 to 6 carbon atoms, preferably 1 to 3 carbon atoms, for example, alkyl groups such as methyl, ethyl, propyl, isopropyl, butyl, tert-butyl, pentyl, and hexyl; cycloalkyl groups such as cyclopentyl and cyclohexyl; aryl groups such as phenyl; and alkenyl groups such as vinyl and allyl; with methyl being most preferred. At each occurrence, R² may be the same or different.

L is an integer of 18 to 48, and preferably 28 to 38. Accordingly the organopolysiloxane content in the copolymer (C) is preferably 5 to 50% by weight, more preferably 10 to 30% by weight, which is determined by considering the copolymer's dispersion in and compatibility with the epoxy resin composition and a stress-reducing ability of the epoxy resin composition.

An appropriate amount of the copolymer (C) added is 0.1 to 20 parts by weight, more preferably 0.5 to 10 parts by weight per 100 parts by weight of the epoxy resin (A) and the curing agent (B) combined. Less than 0.1 part of the copolymer may fail to provide satisfactory thermal cycling properties whereas more than 20 parts of the copolymer may cause obstructed flow and increased water absorption.

D. Inorganic Filler

The inorganic filler (D) included in the epoxy resin compositions of the invention may be any suitable inorganic filler commonly used in epoxy resin compositions. Illustrative examples include silicas such as fused silica and crystalline silica, alumina, silicon nitride, aluminum nitride, boron nitride, titanium oxide, glass fibers, and antimony trioxide. No particular limit is imposed on the average particle size and shape of these inorganic fillers as well as the amount thereof. To enhance the crack resistance upon lead-free soldering and flame retardance, the inorganic filler is preferably contained in a larger amount in the epoxy resin composition insofar as this does not compromise moldability.

With respect to the mean particle size and shape of the inorganic filler, spherical fused silica having a mean particle size of 3 to 30 μm, especially 5 to 25 μm is more preferred. It is noted that the mean particle size can be determined as the weight average value or median diameter in particle size distribution measurement by the laser light diffraction technique, for example.

The inorganic filler used herein is preferably surface treated beforehand with a coupling agent such as a silane coupling agent or a titanate coupling agent in order to increase the bonding strength between the resin and the inorganic filler. The preferred coupling agents are silane coupling agents including epoxy silanes such as γ-glycidoxypropyltrimethoxysilane, γ-glycidoxypropylmethyldiethoxysilane, γ-isocyanatopropyltriethoxysilane, γ-ureidopropyltriethoxysilane, and β-(3,4-epoxycyclohexyl)ethyltrimethoxysilane; amino silanes such as N-(β-aminoethyl)-γ-aminopropyltrimethoxysilane, γ-aminopropyltriethoxysilane, and N-phenyl-γ-aminopropyltrimethoxysilane; mercapto silanes such as γ-mercaptopropyltrimethoxysilane; and reaction products of imidazole compounds with γ-glycidoxypropyltrimethoxysilane. These coupling agents may be used alone or in admixture. No particular limitation is imposed on the amount of coupling agent used for surface treatment or the method of surface treatment.

The amount of the inorganic filler (C) loaded is preferably 200 to 1,100 parts, more preferably 500 to 800 parts by weight per 100 parts by weight of the epoxy resin (A) and curing agent (B) combined. A composition with less than 200 pbw of the inorganic filler may have an increased coefficient of expansion, allowing the packages to undergo more warpage so that more stresses may be applied to the semiconductor devices, detracting from the device performance. Additionally, the resin content relative to the entire composition becomes higher, detracting from moisture resistance and crack resistance. A composition with more than 1,100 pbw of the inorganic filler may have too high a viscosity to mold. The content of inorganic filler is preferably 75 to 91% by weight, more preferably 78 to 89% by weight, even more preferably 83 to 87% by weight based on the entire composition.

E. Cure Accelerator

For promoting the cure reaction of the epoxy resin with the curing agent (phenolic resin), a cure accelerator is often used. The cure accelerator is not particularly limited as long as it can promote cure reaction. Useful cure accelerators include phosphorus compounds such as triphenylphosphine, tributylphosphine, tri(p-methylphenyl)phosphine, tri(nonylphenyl)phosphine, triphenylphosphine triphenylborane, tetraphenylphosphine tetraphenylborate and triphenylphosphine benzoquinone adduct; tertiary amine compounds such as triethylamine, benzyldimethylamine, α-methylbenzyldimethylamine, and 1,8-diazabicyclo[5.4.0]undecene-7; and imidazole compounds such as 2-methylimidazole, 2-phenylimidazole, and 2-phenyl-4-methylimidazole.

The cure accelerator may be used in an effective amount for promoting the cure reaction of the epoxy resin with the curing agent. When the cure accelerator is a phosphorus compound, tertiary amine compound or imidazole compound, it is preferably used in amounts of 0.1 to 3 parts by weight, more preferably 0.5 to 2 parts by weight per 100 parts by weight of the epoxy resin (A) and curing agent (B) combined.

Other Components

In addition to the foregoing components, the epoxy resin compositions of the invention may further include various additives, if necessary, and insofar as the objects and advantages of the invention are not impaired. Exemplary additives include waxes such as carnauba wax, higher fatty acids, and synthetic waxes; stress reducing agents such as thermoplastic resins, thermoplastic elastomers, organic synthetic rubbers, and silicones; halogen trapping agents, and other additives.

Any parting agents well known in the art can be used herein. Exemplary parting agents include carnauba wax, rice wax, polyethylene, polyethylene oxide, montanic acid, and montan waxes in the form of esters of montanic acid with saturated alcohols, 2-(2-hydroxyethylamino)ethanol, ethylene glycol, glycerin or the like; stearic acid, stearic esters, stearamides, ethylene bisstearamide, ethylene-vinyl acetate copolymers, and the like, alone or in admixture of two or more. The parting agent is desirably included in an amount of 0.1 to 5 parts, more desirably 0.3 to 4 parts by weight per 100 parts by weight of components (A) and (B) combined.

Preparation

The inventive epoxy resin compositions may be prepared as a molding material by compounding components (A) to (D) and optional additives in predetermined proportions, intimately mixing these components together in a mixer or the like, then melt working the resulting mixture in a hot roll mill, kneader, extruder or the like. The mixture is then cooled and solidified, and subsequently ground to a suitable size so as to give a molding material.

When the components are mixed in a mixer or the like to form a uniform composition, it is preferred for improved shelf stability of the resulting composition to add a silane coupling agent as a wetter to carry out previous surface treatment. Examples of suitable silane coupling agents include γ-glycidoxypropyltrimethoxysilane, γ-glycidoxypropylmethyldiethoxysilane, γ-glycidoxypropyltriethoxysilane, p-styryltrimethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropylmethyldimethoxysilane, γ-mercaptopropyltrimethoxysilane, bis(triethoxypropyl)tetrasulfide, and γ-isocyanatopropyltriethoxysilane. No particular limits are imposed on the amount of silane coupling agent used for surface treatment and the surface treating procedure.

The resulting epoxy resin compositions of the invention can be effectively used for encapsulating various types of semiconductor devices. The composition is typically applied to a semiconductor part having a semiconductor chip mounted on one surface of a resin or metal substrate wherein substantially only the one surface having the semiconductor chip mounted thereon is to be sealed with the composition. The composition is preferably applied to encapsulation of Ball Grid Array (BGA) or Quad Flat Package (QFP). The encapsulation method most commonly used is low-pressure transfer molding. The epoxy resin composition of the invention is preferably molded and cured at a temperature of about 150 to 185° C. for a period of about 30 to 180 seconds, followed by post-curing at about 150 to 185° C. for about 2 to 20 hours.

### EXAMPLE

Examples and Comparative Examples are given below for further illustrating the invention, but are not intended to limit the invention. All parts are by weight.

### Examples 1-10 & Comparative Examples 1-6

Epoxy resin compositions for semiconductor encapsulation were prepared by uniformly melt mixing the components shown in Table 1 in a hot twin-roll mill, followed by cooling and grinding. The components used are identified below.

Epoxy Resin

Epoxy resins of formula (1) include epoxy resins A, B and C of the following structures having different values of m and n. Epoxy resins (a) to (d) which are mixtures of epoxy resins A, B and C blended in the proportion shown in Table 1 were used as well as an epoxy resin (e) which is a biphenyl aralkyl type epoxy resin NC3000 (Nippon Kayaku Co., Ltd.). Note that G is as defined above.

Epoxy resin A (m=0, n=0)

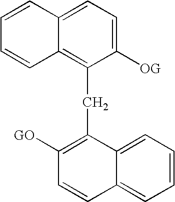

Epoxy resin B (m=1, n=0, or m=0, n=1)

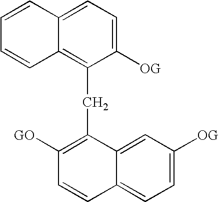

Epoxy resin C (m=1, n=1)

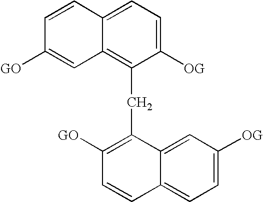

TABLE 1
Blending proportion (parts by weight)

| | Epoxy resin A | Epoxy resin B | Epoxy resin C |
|---|---|---|---|
| Epoxy resin (a) | 60 | 30 | 10 |
| Epoxy resin (b) | 50 | 35 | 15 |
| Epoxy resin (c) | 100 | 0 | 0 |
| Epoxy resin (d) | 50 | 0 | 50 |

Phenolic Resin

A phenolic resin (f) has the following formula.

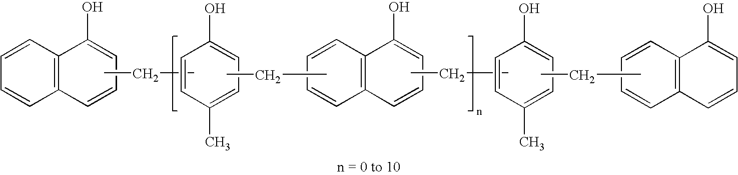

A phenolic resin (g) is a novolac type phenolic resin TD-2131 (Dainippon Ink & Chemicals, Inc.)

Copolymer

Copolymers (h) to (k) are obtained through addition reaction of an alkenyl-containing epoxy compound with an organohydrogenpolysiloxane and have above formula (3) wherein R¹ ^{_{—CH}}₃, R² is —H, R³ is —OCH₂—CH(OH)—CH₂—O—CH₂CH₂CH₂—, p=18, and q=18.

| Copolymer | Number of silicon atom per molecule, L | Siloxane content |
|---|---|---|
| (h) | 28 | 16 wt % |
| (i) | 38 | 21.2 wt % |
| (j) | 58 | 32 wt % |
| (k) | 98 | 53.2 wt % |

Inorganic Filler

Spherical fused silica by Tatsumori K.K.

Other Additives

Cure accelerator: triphenylphosphine (Hokko Chemical Co., Ltd.)

Colorant: #3230B (Mitsubishi Chemical Co., Ltd.)

Parting agent: Carnauba Wax (Nikko Fine Products Co., Ltd.)

Silane coupling agent: γ-glycidoxypropyltrimethoxysilane KBM-403 (Shin-Etsu Chemical Co., Ltd.)

Properties (i) to (vii) of the compositions were measured by the following methods. The results are shown in Table 2.

(i) Spiral Flow

Measured by molding at 175° C. and 6.9 N/mm² for a molding time of 120 seconds using a mold in accordance with EMMI standards.

(ii) Melt Viscosity

Viscosity was measured at a temperature of 175° C. and a pressure of 10 kgf by an extrusion plastometer through a nozzle having a diameter of 1 mm.

(iii) Glass Transition Temperature (Tg) and Coefficient of Linear Expansion (CE)

Measured by molding at 175° C. and 6.9 N/mm² for a molding time of 120 seconds using a mold in accordance with EMMI standards.

(iv) Water Absorption

The composition was molded at 175° C. and 6.9 N/mm² for 2 minutes into a disc of 50 mm diameter and 3 mm thick and post-cured at 180° C. for 4 hours. The disc was held in a temperature/moisture controlled chamber at 85° C. and 85% RH for 168 hours, following which a percent water absorption was determined.

(v) Warpage

A silicon chip of 10×10×0.3 mm was mounted on a bismaleimide triazine (BT) resin substrate of 0.40 mm thick. The composition was transfer molded at 175° C. and 6.9 N/mm² for 2 minutes and post-cured at 175° C. for 5 hours, completing a package of 32×32×1.2 mm. Using a laser three-dimensional tester, the height of the package was measured in a diagonal direction to determine changes, the maximum change being a warpage.

(vi) Reflow Resistance

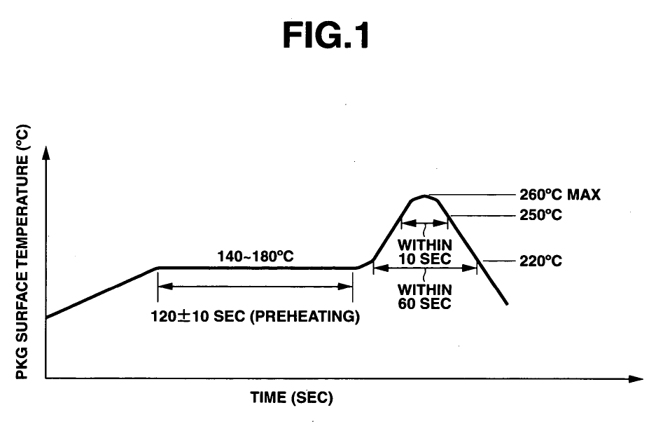

The package used in the warpage measurement was held in a temperature/moisture controlled chamber at 85° C. and 60% RH for 168 hours for moisture absorption. Using an IR reflow apparatus, the package was subjected to three cycles of IR reflow under the conditions shown in FIG. 1. Using a ultrasonic flaw detector, the package was inspected for internal cracks and delamination.

(vii) Thermal Cycling

A silicon chip of 7×7×0.3 mm was mounted on a 100-pin QFP with a copper frame of 14×20×1.4 mm. The composition was molded at 175° C. and 6.9 N/mm² for 120 seconds and post-cured at 175° C. for 5 hours, completing a package. Six packages thus prepared were subjected to 100 cycles of a thermal cycling test involving liquefied nitrogen (−176° C.)×60 sec and 260° C. solder×30 sec. The number of cracked packages was reported.

TABLE 2

| | | Example | | | | | | | | | |
|---|---|---|---|---|---|---|---|---|---|---|---|
| | | 1 | 2 | 3 | 4 | 5 | 6 | 7 | 8 | 9 | 10 |
| (A) Epoxy resin | (a) | 37 | 43 | 39 | 45 | 48 | 51 | 25 | 35 | | |
| | (b) | | | | | | | | | 37 | 43 |
| | (c) | | | | | | | | | | |
| | (d) | | | | | | | | | | |
| | (e) | | | | | | | | | | |
| (B) Phenolic | (f) | 38 | 38 | 18 | 18 | 40 | 40 | 37 | 37 | 38 | 38 |
| resin | (g) | | | 18 | 18 | | | | | | |
| (C) Copolymer | (h) | 25 | | 25 | | 12 | | 38 | | 25 | |
| | (i) | | 19 | | 19 | | 9 | | 28 | | 19 |
| | (j) | | | | | | | | | | |
| | (k) | | | | | | | | | | |

| (D) Inorganic filler | | 600 | 600 | 600 | 600 | 600 | 600 | 600 | 600 | 600 | 600 |
|---|---|---|---|---|---|---|---|---|---|---|---|
| (E) Cure accelerator | | 1 | 1 | 1 | 1 | 1 | 1 | 1 | 1 | 1 | 1 |
| Other | Silane | 1 | 1 | 1 | 1 | 1 | 1 | 1 | 1 | 1 | 1 |
| additives | coupling agent | | | | | | | | | | |
| | Carnauba Wax | 3 | 3 | 3 | 3 | 3 | 3 | 3 | 3 | 3 | 3 |
| Spiral flow, cm | | 120 | 125 | 125 | 130 | 125 | 130 | 115 | 120 | 120 | 125 |
| Melt viscosity, Pa · s | | 9 | 8 | 8 | 7 | 8 | 7 | 10 | 9 | 9 | 8 |
| Tg, ° C. | | 153 | 153 | 147 | 147 | 155 | 155 | 155 | 155 | 155 | 155 |
| CE, ppm | | 8 | 8 | 8 | 8 | 8 | 8 | 8 | 8 | 8 | 8 |
| Water absorption, % | | 0.15 | 0.15 | 0.16 | 0.16 | 0.15 | 0.16 | 0.16 | 0.16 | 0.17 | 0.17 |
| Warpage, μm | | 30 | 25 | 35 | 40 | 30 | 25 | 35 | 30 | 30 | 25 |
| Reflow | crack | 0/20 | 0/20 | 0/20 | 0/20 | 0/20 | 0/20 | 0/20 | 0/20 | 0/20 | 0/20 |
| resistance, | delamination | 0/20 | 0/20 | 0/20 | 0/20 | 0/20 | 0/20 | 0/20 | 0/20 | 0/20 | 0/20 |
| defectives* | | | | | | | | | | | |

| | | | | | | | | | | |
|---|---|---|---|---|---|---|---|---|---|---|
| Thermal cycling, | 0/6 | 0/6 | 0/6 | 0/6 | 0/6 | 0/6 | 0/6 | 0/6 | 0/6 | 0/6 |
| defectives* | | | | | | | | | | |

| | | Comparative Example | | | | | |
|---|---|---|---|---|---|---|---|
| | | 1 | 2 | 3 | 4 | 5 | 6 |
| (A) Epoxy resin | (a) | 59 | 49 | 53 | | | |
| | (b) | | | | | | |
| | (c) | | | | 60 | | |
| | (d) | | | | | 57 | |
| | (e) | | | | | | 66 |
| (B) Phenolic | (f) | 41 | 39 | 39 | 40 | 43 | 34 |
| resin | (g) | | | | | | |
| (C) Copolymer | (h) | | | | | | |
| | (i) | | | | | | |
| | (j) | | 12 | | | | |
| | (k) | | | 8 | | | |

| (D) Inorganic filler | | 600 | 600 | 600 | 600 | 600 | 600 |
|---|---|---|---|---|---|---|---|
| (E) Cure accelerator | | 1 | 1 | 1 | 1 | 1 | 1 |
| Other | Silane | 1 | 1 | 1 | 1 | 1 | 1 |
| additives | coupling agent | | | | | | |
| | Carnauba Wax | 3 | 3 | 3 | 3 | 3 | 3 |
| Spiral flow, cm | | 130 | 125 | 130 | 145 | 105 | 120 |
| Melt viscosity, Pa · s | | 7 | 8 | 7 | 5 | 12 | 11 |
| Tg, ° C. | | 153 | 153 | 153 | 133 | 160 | 132 |
| CE, ppm | | 8 | 8 | 8 | 9 | 7 | 11 |
| Water absorption, % | | 0.15 | 0.16 | 0.16 | 0.18 | 0.20 | 0.18 |
| Warpage, μm | | 30 | 35 | 35 | 120 | 20 | 250 |
| Reflow | crack | 0/20 | 0/20 | 0/20 | 0/20 | 4/20 | 0/20 |
| resistance, | delamination | 0/20 | 0/20 | 0/20 | 0/20 | 9/20 | 0/20 |
| defectives* | | | | | | | |

| | | | | | | |
|---|---|---|---|---|---|---|
| Thermal cycling, | 6/6 | 3/6 | 5/6 | 6/6 | 6/6 | 6/6 |
| defectives* | | | | | | |

*defective samples/test samples

Japanese Patent Application No. 2005-322754 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A semiconductor encapsulating epoxy resin composition comprising
(A) a naphthalene type epoxy resin having the general formula (1): 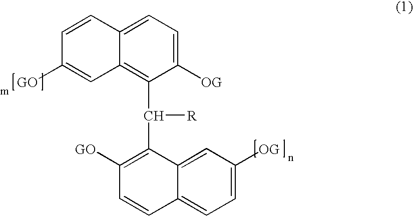
wherein m and n are 0 or 1, R is hydrogen, C₁-C₄ alkyl or phenyl, and G is a glycidyl-containing organic group, with the proviso that 35 to 85 parts by weight of the resin wherein m=0 and n=0 and 1 to 35 parts by weight of the resin wherein m=1 and n=1 are included per 100 parts by weight of the resin of formula (1),
(B) a phenolic resin curing agent,
(C) a copolymer obtained through addition reaction of alkenyl groups on an alkenyl-containing epoxy compound and SiH groups on an organopolysiloxane having the average compositional formula (2):
HₐR¹_{b}SiO_{(4-a-b)/2} (2)
wherein R¹ is substituted or unsubstituted monovalent hydrocarbon group, hydroxyl group or alkoxy group, a is a positive number of 0.01 to 1, b is a positive number of 1 to 3, and the sum a+b is from 1 to 4, the number of silicon atoms per molecule is an integer of 20 to 50, and the number of silicon-bonded hydrogen atoms per molecule is an integer of at least 1, and
(D) an inorganic filler.

2. The epoxy resin composition of claim 1, wherein the copolymer (C) has the structural formula (3): 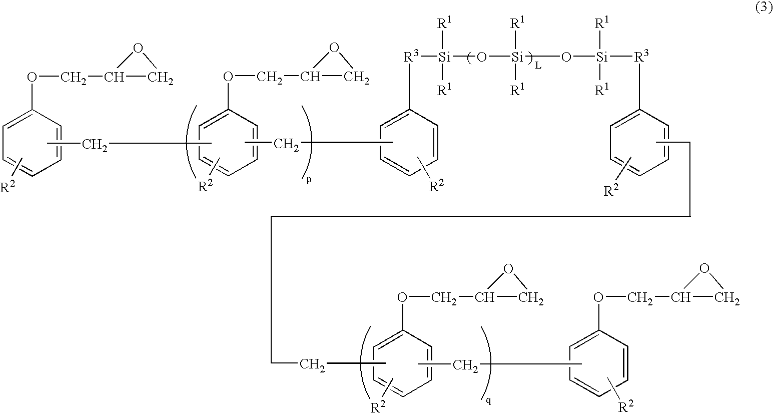
wherein R¹ is as defined above, R² is hydrogen or a monovalent hydrocarbon group of 1 to 6 carbon atoms, R³ is —CH₂CH₂CH₂—, —OCH₂—CH(OH)—CH₂—O—CH₂CH₂CH₂— or —O—CH₂CH₂CH₂—, L is an integer of 18 to 48, preferably 28 to 38, and p and q each are an integer of 1 to 100, preferably 2 to 50.

3. A semiconductor device encapsulated with the epoxy resin composition of claim 1.
